(19) United States
(12) Patent Application Publication
(10) Pub. No.: US 2004/0204777 A1
(43) Pub. Date: Oct. 14, 2004

(54) Precision motion control using feed forward of acceleration

(76) Inventor: Alon Harpaz, Ashland, MA (US)

Correspondence Address: Choate, Hall & Stewart, Exchange Place, 53 State Street, Boston, MA, 02109, US

(21) Appl. No.: 10/413,027

(22) Filed: Apr. 14, 2003

(51) Int. Cl. G05B 19/18

(52) U.S. Cl. 700/63; 700/56

(57) ABSTRACT

High precision position control apparatus. An object supported on a frame of reference is moved by an actuator. A position sensor generates a position signal and an acceleration sensor affixed to the frame of reference generates an acceleration signal. A control system responds to the position signal and the acceleration signal to control the actuator to move the object to follow a commanded trajectory with reduced following error.

### BACKGROUND OF THE INVENTION

This invention relates to motion control and more particularly, to high precision motion control employing the feeding forward of an acceleration signal.

High precision machines commonly attempt to position a moving element such as a substrate, work-piece, mask, or process equipment relative to a frame of reference. A common frame of reference is a massive granite base on which are mounted the moving element and an actuator affixed to the granite base for moving the moving element. As those skilled in the art will recognize, granite bases are themselves mounted with respect to the building in which they are housed in a way to minimize the introduction of motion to the granite base from external sources. Nonetheless, external influences can cause the base to move. More importantly, the base is disturbed when the object to be positioned is moved. That is, reaction forces on the granite base arising from the motion of the object to be positioned will cause the base itself to move. In some applications, the frame of reference may be commanded to move on its own. In all of these situations, base motion degrades the performance of the precision positioning system.

To maintain a desired position of an object relative to the frame of reference, a control system has to develop the necessary forces on the object to be moved. In a typical control system that accepts position information and a commanded trajectory, the development of the appropriate force requires that some following error exists between the desired position and the actual position of the moving element, thereby leading to a degradation in performance. It is known to compensate in advance for some known base motion by predicting the motion of the frame of reference and feeding the necessary information into the control system that controls the position of the moving element. Such information is not always available and is especially unpredictable when the frame of reference moves because of internal or external disturbances.

It is also known to utilize an acceleration signal in a feed forward manner in a lithographic apparatus. See U.S. Pat. No. 6,420,716 B1. This patent attempts to compensate for motion of a projection system.

### SUMMARY OF THE INVENTION

In one aspect, the apparatus of the invention for controlling motion of a moveable object supported on a frame of reference structure includes a structure serving as a frame of reference. A moveable object is supported by the structure for motion with respect to the structure. An actuator is affixed to the structure and adapted to move the moveable object with respect to the structure. A position sensor responsive to position of the moveable object with respect to the frame of reference structure is provided to generate a position signal. In addition, an acceleration sensor is affixed to the frame of reference structure to generate an acceleration signal. A control system responsive to the position and acceleration signals is provided to control the actuator to move the object to follow a commanded trajectory. In a preferred embodiment, the control system includes a PID servo filter and a signal proportional to the acceleration signal is added to the output of the PID servo filter. In this embodiment, an amplifier is provided to drive the actuator such that the amplifier is responsive to the sum of the acceleration signal and the output of the PID servo filter. A suitable frame of reference structure is a granite base.

### BRIEF DESCRIPTION OF THE DRAWING

FIG. 1 is a schematic illustration of an embodiment of the invention.

FIG. 2 is a graph of following error vs. time for an embodiment of the invention with an acceleration signal being used.

FIG. 3 is a graph of following error vs. time for a system not using an acceleration signal.

### DESCRIPTION OF THE PREFERRED EMBODIMENT

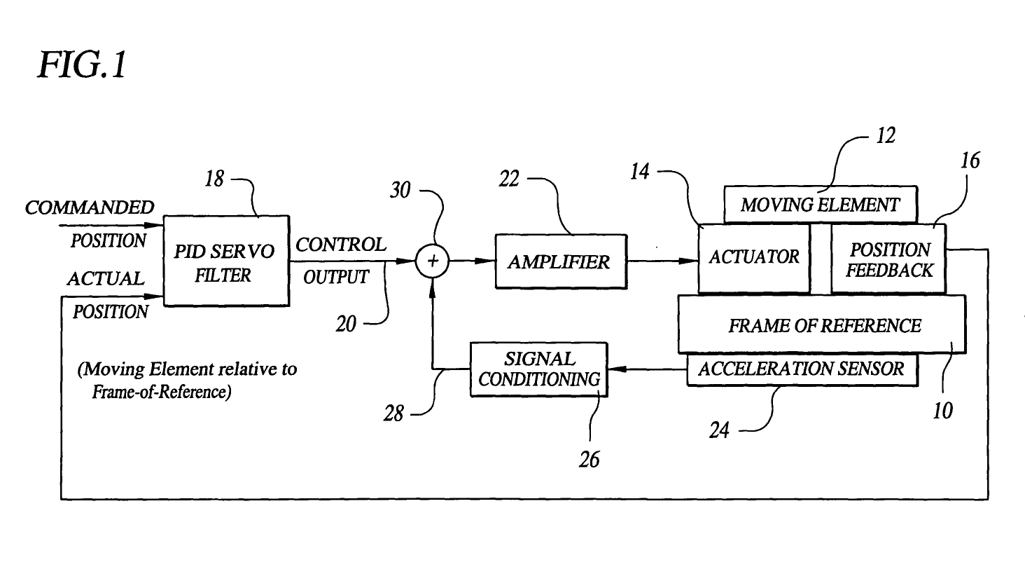

With reference first to FIG. 1, a frame of reference or base 10 may be, for example, a granite machine base, as is well known in the art. The base may be supported on isolation supports to minimize external disturbances. A moving element 12 may be, for example, a substrate, work-piece, mask, or any process equipment supported for motion with respect to the frame of reference 10. The moving element 12 may move in multiple degrees of freedom, but is illustrated in FIG. 1 for a single degree of freedom. The moving element 12 is typically supported on the base 10 in a low friction manner such as with ball bearings or air bearings.

An actuator 14 is rigidly affixed to the base 10 and is arranged to apply forces to the moving element 12 so as to move it with respect to the base 10. A position feedback sensor 16 responds to the position of the moving element 12 with respect to the base 10 and sends a position feedback signal to a PID servo filter 18. As those skilled in the art will recognize, a PID servo filter is a proportional-integral-derivative servo controller. As is well known, the PID servo filter 18 compares a commanded position with the measured position to generate a control output signal 20 that provides an input to an amplifier 22 that drives the actuator 14. As those skilled in the art will appreciate, a following error must exist between the desired position and the actual position of the moving element in order for a PID servo controller to develop the necessary force, leading to a degradation in performance.

In order to reduce such following error, especially in the presence of base 10 motion, an acceleration sensor 24 is rigidly attached to the base 10. The acceleration sensor 24 generates an output signal which serves as an input to a signal conditioning element 26. As those skilled in the art will appreciate, the signal conditioning element 26 may be merely a selected gain constant. An output signal 28 from the signal conditioning element 26 is combined with the control output signal 20 at a summing junction 30. The signal 28 thus modifies the command to the amplifier 22 in such a way that a modified force will be applied by the actuator 14 to the moving element 12. The modified force is sufficient to accelerate the moving element 12 such that the moving element 12 “stays with” the frame of reference or base 10 thereby reducing any following error to be within an acceptable bound.

The present invention has been implemented on a large gantry type AC 3500 positioning platform manufactured by Danaher Corporation of Westborough, Mass. Such a machine is used in the manufacture of high precision substrates for electronic equipment. A typical application for this machine requires that the moving axis be within ±5 μm of a commanded final position before subsequent process steps can be conducted. For this machine, the moving axis moves in increments of 131 mm and throughput considerations mandate that the settling criterion (±5 μm) be achieved within approximately 525 ms after the move has begun.

The accelerometer 24 used in this exemplary implementation is designated as part number LCF-165 from Jewel Instruments, LLC, of Manchester, N.H. A suitable position feedback sensor 16 is a linear encoder with a resolution of 50 nm/count. The settling criterion of ±5 m is therefore equivalent to ±100 counts from the position sensor 16.

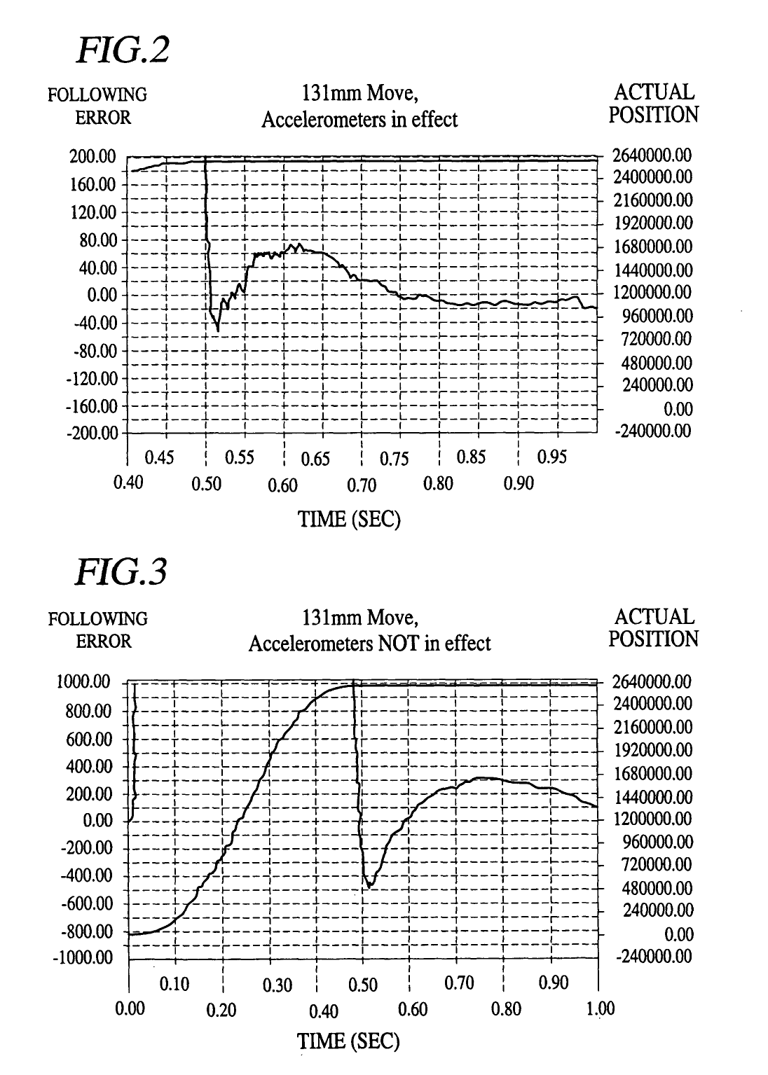

Experiments were conducted both with the acceleration sensor 24 in effect and not in effect. FIG. 2 is a plot of following error versus time for a 131 mm move with the acceleration sensor 24 employed in the control loop. As shown, the following error (in counts) decreased to less than ±100 counts at approximately 510 ms after the beginning of the move. Residual oscillations are evident but are within the settling tolerance. FIG. 3 is a plot of following error measured in counts as a function of time but with the acceleration sensor 24 not being used in the control loop. FIG. 3 shows the strong effect of base 10 rocking on the settling process. As shown, the following error exceeds 400 counts (20 μm) at its first peak at about 520 ms and exceeds 250 counts (12.5 μm) at its second peak at about 780 ms. Such a performance level is unacceptable because the long delay in settling adds significant time to customer process steps and reduces throughput accordingly.

It should be noted that inertial sensors such as gyroscopes or inclinometers may be used in place of an accelerometer. It will be appreciated that when more than one degree of freedom is being controlled there will be inertial instruments about multiple axes.

It is recognized that modifications and variations of the invention disclosed herein will be apparent to those skilled in the art and all such modifications and variations are included within the scope of the appended claims.

What is claimed is:

1. Apparatus for controlling motion of a movable object supported on a frame of reference structure comprising:
a structure serving as a frame of reference;
a movable object supported by the structure for motion with respect to the structure;
an actuator affixed to the structure for moving the movable object with respect to the structure;
a position sensor responsive to position of the movable object with respect to the frame of reference structure to generate a position signal;
an acceleration sensor affixed to the frame of reference structure to generate an acceleration signal; and
a control system responsive to the position and acceleration signals to control the actuator to move the object to follow a commanded trajectory.

2. The apparatus of claim 1 wherein the control system includes a PID servo filter.

3. The apparatus of claim 2 wherein a signal proportional to the acceleration signal is added to an output of the PID servo filter.

4. The apparatus of claim 1 wherein the frame of reference structure is a granite base.

5. The apparatus of claim 3 further including an amplifier for driving the actuator, the amplifier responsive to the sum of the acceleration signal and the output of the PID servo filter.

6. The apparatus of claim 1 wherein the acceleration sensor is an accelerometer.

7. The apparatus of claim 1 wherein the acceleration sensor is a gyroscope.

8. The apparatus of claim 1 wherein the acceleration sensor is an inclinometer.
